(19) United States
(12) Patent Application Publication
(10) Pub. No.: US 2019/0278724 A1
(43) Pub. Date: Sep. 12, 2019

(54) KEYBOARD-VIDEO-MOUSE SWITCH, SIGNAL PROCESSING METHOD, AND NON-TRANSITORY COMPUTER-READABLE STORAGE MEDIUM

(71) Applicant: I/O INTERCONNECT, LTD., SANTA ANA, CA (US)

(72) Inventors: Kun-Yuan LIN, Taipei (TW); Tsung-Min Chen, Taipei (TW)

(21) Appl. No.: 15/914,220

(22) Filed: Mar. 7, 2018

(51) Int. Cl. G06F 13/22; G06F 3/14; G06F 3/023; G06F 3/02; G06F 13/10; G06F 13/40

(52) U.S. Cl. CPC G06F 13/22; G06F 3/14; G06F 13/4081; G06F 3/0227; G06F 13/105; G06F 3/023

(57) ABSTRACT

A KVM switch is disclosed. The KVM switch, for connecting between a plurality of computers and an input/output device, the KVM switch includes a secure controller, a plurality of peripheral emulators and a peripheral interface. The secure controller is configured to determine whether to send the video signal to the input/output device through a video channel. Each of the peripheral emulators is configured to receive a peripheral signal from the secure controller and send the peripheral signal to the computers. The peripheral interface is configured to send the peripheral signal to the secure controller, wherein, the secure controller configured to determine whether the input/output device is connected or not, if the input/output device is not connected, the secure controller is disabling the video channel to stop the video signal sending.

### FIELD OF INVENTION

The invention relates to a keyboard-video-mouse switch, a signal processing method, and a non-transitory computer-readable storage medium. More particularly, the invention relates to a keyboard-video-mouse switch, a signal processing method, and a non-transitory computer-readable storage medium for determining whether a video signal is sent to other device.

### BACKGROUND

Recently, the switching system (for example, a Keyboard-Video-Mouse (KVM) system) switches has been widely used, one or more groups keyboard, one or more video screen, and one or more computer mouse via a user to remotely control multiple computers. Generally, the user utilizes an electronic switch to switches the keyboard, the display, and the mouse. However, if the display is removed or replaced, the computer still outputs a video signal, this situation will cause when the display to be connect again, the display may be installed a screen recorder. Therefore, how to prevent the data leakage in KVM switch system is one of the problems to be improved in the art.

### SUMMARY

An embodiment of this disclosure is to provide a KVM switch, for connecting between a plurality of computers and an input/output device, the KVM switch includes a secure controller, a plurality of peripheral emulators and a peripheral interface. The peripheral emulators are coupled to the computers and the secure controller. The peripheral interface is coupled to the input/output device and the secure controller. The secure controller is configured to determine whether to send the video signal to the input/output device through a video channel. Each of the peripheral emulator is configured to receive a peripheral signal from the secure controller and send the peripheral signal to the computers. The peripheral interface is configured to send the peripheral signal to the secure controller, wherein, the secure controller configured to determine whether the input/output device is connected or not, if the input/output device is not connected, the secure controller is disabling the video channel to stop the video signal sending.

An embodiment of this disclosure is to provide a signal processing method for a KVM switch, the signal processing method includes the following operations: receiving a peripheral signal from a peripheral interface; sending the peripheral signal to a plurality of computers; receiving a video signal from the computers; determining whether the input/output device is connected or not; if the input/output device is connected to the peripheral interface, sending the video signal to the input/output device through a video channel; and if the input/output device is not connected to the peripheral interface, disabling the video channel so as to stop the video signal sending.

The embodiment of the present disclosure is to provide a non-transitory computer-readable storage medium storing a computer program performing a signal processing method for a KVM switch. The signal processing method includes the following operations: receiving a peripheral signal from a peripheral interface; sending the peripheral signal to a plurality of computers; receiving a video signal from the computers; determining whether the input/output device is connected or not; if the input/output device is connected to the peripheral interface, sending the video signal to the input/output device through a video channel; and if the input/output device is not connected to the peripheral interface, disabling the video channel so as to stop the video signal sending.

The present disclosure is to provide a keyboard-video-mouse switch, a signal processing method, and a non-transitory computer-readable storage medium. The disclosure mainly utilizes the secure controller to control the video signal cannot be output when the display is not connected to the KVM switch. Therefore, the disclosure can avoid the video signal leakage in KVM switch system, thus achieving the safe transmitting of the video signal in KVM switch system.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a functional block diagram illustrating a KVM switch according to some embodiments of the present disclosure.

FIG. 2 is a flow diagram illustrating a signal processing method according to an embodiment of this disclosure.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention.

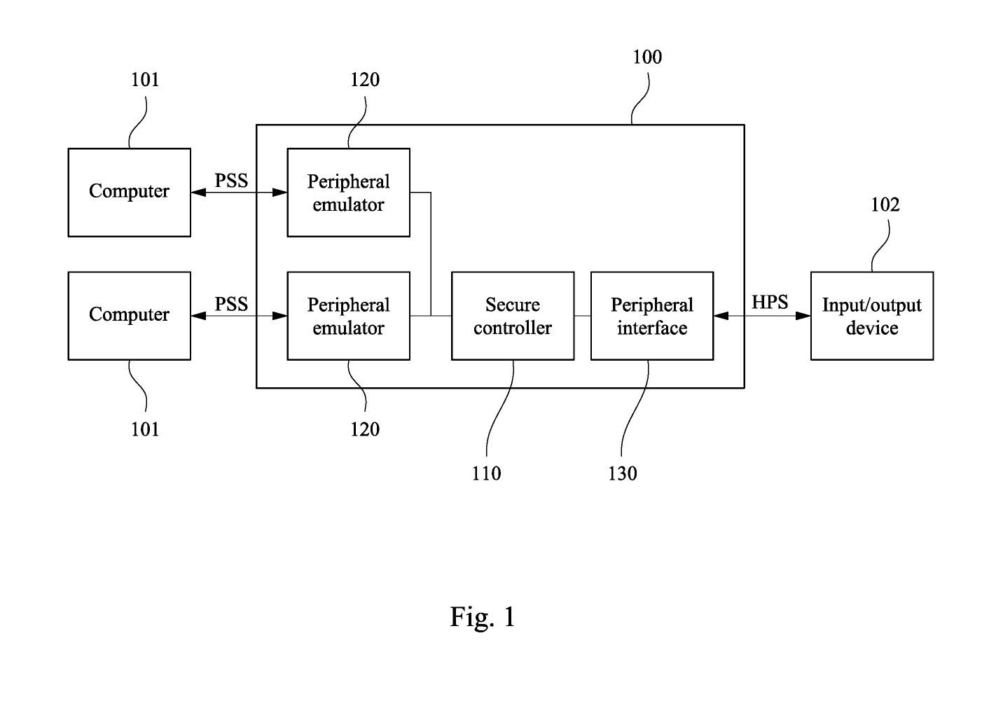

Reference is made to FIG. 1. FIG. 1 is a schematic diagram illustrating a KVM switch 100 according to some embodiments of the present disclosure. As illustrated in FIG. 1, the KVM switch 100 is connected between a plurality of computers 101 and an input/output device 102. The KVM switch 100 includes a secure controller 110, a plurality of peripheral emulators 120, and peripheral interface 130. In some embodiments, the connection between the KVM switch 100, the computers 101 and the input/output device 102 may be wire connection or wireless connection. The KVM switch 100 shown in FIG. 1 is for illustrative purposes only and the present disclosure is not limited thereto.

In some embodiments, the secure controller 110 is electrically coupled to the peripheral emulators 120 and peripheral interface 130. Each of the peripheral emulators 120 is electrically coupled to the computers 101, and the peripheral interface 130 is electrically coupled to the input/output device 102. The secure controller 110 is configured to determine whether to send the video signal to the input/output device 102 through a video channel. Each of the peripheral emulator 120 is configured to receive a peripheral signal from the secure controller 110 and send the peripheral signal to the computers 101. The peripheral interface 130 is configured to send the peripheral signal to the secure controller 110.

In some embodiments, the input/output device 102 can be implemented by a display. The secure controller 110 can be implemented by a micro controller, a microprocessor, a digital signal processor, an application specific integrated circuit (ASIC), a logical circuitry or any equivalent circuits of the secure controller 110. The peripheral emulators 120 are configured to emulate as a standard peripheral device, such as USB, keyboard or mouse. In the embodiments, the peripheral emulators 120 are configured to emulate as the display. (secured KVM is normally utilized for multiple PCs sharing one set of keyboard, mouse, monitor. NOT FOR ONE)

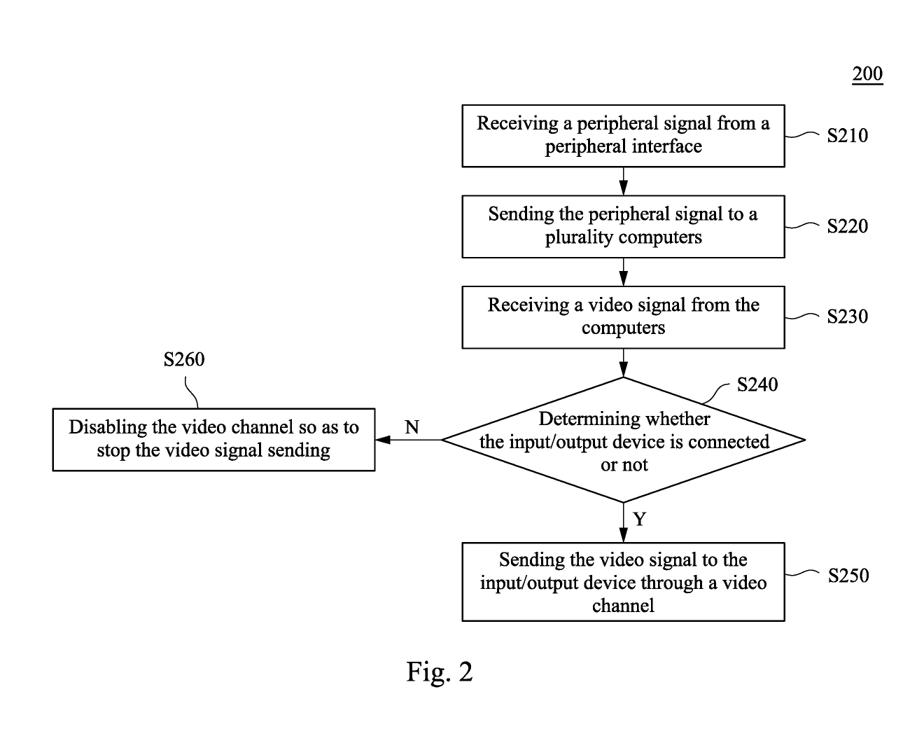

Reference is made to FIG. 2. FIG. 2 is a flow diagram illustrating a signal processing method 200 according to an embodiment of this disclosure. In the embodiment, the signal processing method 200 can be utilized control that a video channel is enabled or disabled. When the video channel is enabling, the KVM switch 100 is configured sending a video signal to the input/output device 102. When the video channel is disabling, the KVM switch 100 is configured to stop sending a video signal to the input/output device 102. For convenience of explanation and understanding, reference is made to both FIG. 1 and FIG. 2.

As the embodiment shown in FIG. 2, the signal processing method 200 firstly executes step S210 to receive a peripheral signal from a peripheral interface 130. In the embodiment, the input/output device 102 is configured to send the peripheral signal to the peripheral interface 130. The peripheral signal includes information of the input/output device, such as an extended display identification data (EDID). The EDID data format includes header information, basic display parameters, chromaticity coordinates, standard timing information and so on.

Afterward, the signal processing method 200 executes step S220 and step S230 to send the peripheral signal to the computers 101 and to receive a video signal from the computers 101. In the embodiment, the secure controller 110 is configured to send the peripheral signal to the peripheral emulators 120, and each of the peripheral emulators 120 is configured to send the peripheral signal to the computers 101. The computers 101 are configured to output the video signal to the secure controller 110 according to the peripheral signal. The computers 101 are configured to send the video signal that matches the display resolution based on EDID data format.

Afterward, the signal processing method 200 executes step S240 to determine whether the input/output device 102 is connected or not. Based on aforesaid embodiments, the secure controller 110 is configured to determine whether to output the video signal to the display based on the connection status between the display and the KVM switch 100. The secure controller 110 further configured to utilize a hot plug detecting signal to determine whether physical line between the peripheral interface 130 and the display is connected.

If the step S240 determines that the input/output device 102 is connected to the peripheral interface 130, the signal processing method 200 executes step S250 to send the video signal to the input/output device 102 through a video channel. If the step S250 determines that the input/output device 102 is disconnected to the peripheral interface 130, the signal processing method 200 executes step S260 to disable the video channel so as to stop the video signal sending.

Based on aforesaid embodiments, after disconnecting the input/output device 102 and the peripheral interface 130, the security controller 110 does not send the video signal to the input/output device 102 if the user reconnects the input/output device 102 and the peripheral interface 130. Only after the administrator resets the security controller, the secure controller 110 will send the video signal to the input/output device 102 again. It is noticed that, whether the user utilizes the same display or using other display to connect with KVM switch 100, the security controller 110 cannot be output the video signal. The video signal is stopped sending until the secure controller 110 is reset. Therefore, this operated method can avoid the video signal leakage in KVM switch system.

In the embodiments, if the power source of KVM switch 100 is interrupted, the secure controller 110 will not be able to control the video signal, it will cause the video signal leakage. Therefore, the secure controller 110 further configured to detect whether the power source is interrupted or not, if the power source is interrupted, the secure controller 110 configured to send a power source signal to the computers 101. The power source signal is configured to notify the administrator that an accident event is occurred on the KVM switch 100.

According to the embodiment of the present disclosure, it is understood that the embodiment of the present disclosure is to provide a keyboard-video-mouse switch, a signal processing method, and a non-transitory computer-readable storage medium; in order to control the video signal cannot be output when the display is not connected to the KVM switch. Therefore, the disclosure can avoid the video signal leakage in KVM switch system, thus achieving the safe transmitting of the video signal in KVM switch system.

In this document, the term “coupled” may also be termed as “electrically coupled”, and the term “connected” may be termed as “electrically connected”. “Coupled” and “connected” may also be used to indicate that two or more elements cooperate or interact with each other. It will be understood that, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

In addition, the above illustrations comprise sequential demonstration operations, but the operations need not be performed in the order shown. The execution of the operations in a different order is within the scope of this disclosure. In the spirit and scope of the embodiments of the present disclosure, the operations may be increased, substituted, changed and/or omitted as the case may be.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A keyboard-video-mouse (KVM) switch, for connecting between a plurality of computers and an input/output device, the KVM switch comprising:
a secure controller configured to determine whether to send a video signal to the input/output device through a video channel;
a plurality of peripheral emulators, coupled to the computers and the secure controller, each of the peripheral emulators being configured to receive a peripheral signal from the secure controller and send the peripheral signal to the computers; and
a peripheral interface, coupled to the input/output device and the secure controller, configured to send the peripheral signal to the secure controller;
wherein, the secure controller configured to determine whether the input/output device is connected or not, if the input/output device is not connected, the secure controller is disabling the video channel to stop the video signal sending until the secure controller is reset;
wherein after disconnecting the input/output device and the peripheral interface, if the input/output device is configured to reconnect to the peripheral interface, the security controller does not send the video signal to the input/output device.

2. (canceled)

3. The KVM switch of claim 1, wherein the peripheral signal comprises information of the input/output device.

4. The KVM switch of claim 3, wherein information of the input/output device comprises an extended display identification data.

5. The KVM switch of claim 1, wherein the secure controller further configured to utilize a hot plug detecting signal to determine whether physical line between the peripheral interface and the input/output device is connected.

6. The KVM switch of claim 1, wherein the secure controller further configured to detect whether a power source is interrupted or not, if the power source is interrupted, the secure controller configured to send a power source signal to the computers.

7. The KVM switch of claim 1, wherein the input/output device comprises a display unit.

8. A signal processing method for a KVM switch, the signal processing method comprising:
receiving a peripheral signal from a peripheral interface;
sending the peripheral signal to a plurality of computers;
receiving a video signal from the computers;
determining whether an input/output device is connected or not;
if the input/output device is connected to the peripheral interface, sending the video signal to the input/output device through a video channel; and
if the input/output device is not connected to the peripheral interface, disabling the video channel so as to stop the video signal sending until a secure controller is reset;
wherein after disconnecting the input/output device and the peripheral interface, if the input/output device is configured to reconnect to the peripheral interface, the security controller does not send the video signal to the input/output device.

9. (canceled)

10. The signal processing method of claim 8, wherein the peripheral signal comprises information of the input/output device.

11. The signal processing method of claim 10, wherein information of the input/output device comprises an extended display identification data.

12. The signal processing method of claim 8, wherein a secure controller further configured to utilize a hot plug detecting signal to determine whether physical line between the peripheral interface and the input/output device is connected.

13. The signal processing method of claim 8, further comprising:
detecting whether a power source is interrupted or not; and
if the power source is interrupted, sending a power source signal to the computers.

14. The signal processing method of claim 8, wherein the input/output device comprises a display unit.

15. A non-transitory computer-readable storage medium storing a computer program performing a signal processing method for a KVM switch, wherein the signal processing method comprises:
receiving a peripheral signal from a peripheral interface;
sending the peripheral signal to a plurality of computers;
receiving a video signal from the computers;
determining whether an input/output device is connected or not;
if the input/output device is connected to the peripheral interface, sending the video signal to the input/output device through a video channel; and
if the input/output device is not connected to the peripheral interface, disabling the video channel so as to stop the video signal sending until a secure controller is reset;
wherein after disconnecting the input/output device and the peripheral interface, if the input/output device is configured to reconnect to the peripheral interface, the security controller does not send the video signal to the input/output device.

16. (canceled)

17. The non-transitory computer-readable storage medium of claim 15, wherein the peripheral signal comprises information of the input/output device.

18. The non-transitory computer-readable storage medium of claim 17, wherein information of the input/output device comprises an extended display identification data.

19. The non-transitory computer-readable storage medium of claim 15, wherein a secure controller further configured to utilize a hot plug detecting signal to determine whether physical line between the peripheral interface and the input/output device is connected.

20. The non-transitory computer-readable storage medium of claim 15, wherein the signal processing method further comprises:
detecting whether a power source is interrupted or not; and
if the power source is interrupted, sending a power source signal to the computers.
